(19) United States
(12) Patent Application Publication
(10) Pub. No.: US 2020/0036658 A1
(43) Pub. Date: Jan. 30, 2020

(54) SYSTEM AND METHOD FOR ASSISTING USER COMMUNICATIONS USING BOTS

(71) Applicant: INZANE LABS PRIVATE LIMITED, Mumbai (IN)

(72) Inventors: Allwin Agnel ELANGO, Mumbai (IN); Sandeep KALIDINDI, Mumbai (IN)

(73) Assignee: INZANE LABS PRIVATE LIMITED, Mumbai (IN)

(21) Appl. No.: 16/094,455

(22) PCT Filed: Jan. 16, 2017
(86) PCT No.: PCT/IB2017/050212

§ 371 Date: Oct. 17, 2018

(30) Foreign Application Priority Data
Apr. 18, 2016 (IN) 201621013390

(51) Int. Cl. H04L 12/58

(52) U.S. Cl. CPC H04L 51/02; H04L 51/04

(57) ABSTRACT

An instant messaging (IM) system is provided. The system includes a client application engine configured for operating on one or more devices. The system includes a bot engine configured for rendering a plurality of instant automated messaging data to user participants of a communication session. The bot engine is integrated within the client application engine or a server or both. The bot engine includes a controller. The controller is configured for monitoring a messaging data being communicated across the user participants of the communication session. The controller is configured for analyzing the messaging data to filter one or more contextual keywords. The controller is further configured for generating automated messaging data based on the one or more contextual keywords. In addition, the controller is configured for displaying the automated messaging data to assist the user participants of the communication session.

### FIELD OF TECHNOLOGY

This disclosure relates generally to instant messaging (IM) systems, and more particularly to a system and method for assisting user participants engaged in a communication session, using a bot engine integrated on at least one client application engine or on server or both.

### BACKGROUND

One of the key aspects of instant messaging systems is to enable several users/persons to participate in a communication session. In one example, the instant messaging systems include one-to-one, one-to-many, and many-to-many communications services and also so-called “Chat Rooms” or ‘groups’. For example, the instant messages may be exchanged in an on-line conversation between two or more users/persons who have access to an instant messaging service and who have installed communications software necessary to access and use the instant messaging service.

Typically, the instant messages may be exchanged between users/persons who have access to an instant messaging service with the requisite communications software. Furthermore, a program may also be installed that is capable of automatically receiving and responding to instant messages without user intervention. Such a program may be referred to as an instant message robot, a BOT, a bot engine or an automated agent or an automaton. For example, the BOT may receive an instant message, identify an appropriate response to the instant message, and send the response automatically. The BOTs may be used to automatically perform tasks that once required a human to perform, such as providing customer service.

Normally, the existing instant messaging services which use BOT engine or automatons require user's instructions or an input from at least one user. Moreover, the BOT engine has restricted access to user's information. For example, as disclosed in granted US patent (U.S. Pat. No. 7,454,469B2), the automatons used are associated with an automated weather reporting service that is configured to respond to questions about any country's weather.

In addition, referring to US patent application (US20140207882A1), automatons may use various databases, such as a cooking/kitchen database, a weather database, a fortune database, a calculator functioning database, a dictionary database, a blog/cafe database, a search advertisement database, a service database configured in a question-and-answer form. Further, in the US patent application (US20120030301A1), automatons may indicate areas of mutual interest among chat participants in the subset, similar responses to one or more multiple-choice questions, diverse responses to one or more multiple-choice questions, wherein, questions can be whimsical, fun, and easy to answer. Furthermore, in the US patent application, (US20130166275A1), software automatons participate in a conversation session in a messaging application to provide a translation of messages into different languages, in real time.

The common problems, as can be seen from the above prior art documents, are that the automatons implemented in the existing technology have limited access to user's information. Another problem which can be seen is that, the majority of prior art documents are directed towards installing the automatons only at the server but not on the user's or client's device. Further, the traditional automatons need user's instructions to function. Moreover, the traditional automatons are configured to store and use the stored data (old set of data) for generating automatic responses.

### SUMMARY

The following summary is illustrative only and is not intended to be in any way limiting. In addition to the illustrative aspects, example embodiments, and features described above, further aspects, example embodiments of the present disclosure will become apparent by reference to the drawings and the following detailed description.

Embodiments of the present disclosure facilitates an integration of a bot engine within a client application engine (for example, an instant messaging service application) and has a capability to access the entire user's information. For example, the information may be the messaging data flowing across the two or more user participants of the communication session. In one embodiment, the bot engines or the automatons do not need to wait for user instructions, to provide suggestions based on the communication between two or more users. Furthermore, it is advantageous to have BOT engines installed on users' or clients' devices to retrieve results quickly.

Example embodiments provide instant messaging (IM) system. The system includes a client application engine configured for operating on one or more devices. The system includes a bot engine configured for rendering a plurality of instant automated messaging data to user participants of a communication session. The bot engine is integrated within the client application engine or a server or both. The bot engine includes a controller. The controller is configured for monitoring a messaging data being communicated across the user participants of the communication session. The controller is configured for analyzing the messaging data to filter one or more contextual keywords. The controller is further configured for generating automated messaging data based on the one or more contextual keywords. In addition, the controller is configured for displaying the automated messaging data to assist the user participants of the communication session.

Also disclosed is a method for rendering automated messaging data to assist one or more user participants of the communication session. The method includes monitoring a messaging data being communicated across the user participants of the communication session. The method also includes analysing the messaging data to filter one or more contextual keywords. In addition, the method includes generating automated messaging data based on the one or more contextual keywords. Moreover, the method includes displaying the automated messaging data to assist the user participants of the communication session.

### BRIEF DESCRIPTION OF THE FIGURES

These and other features, aspects, and advantages of example embodiments will be better understood when the following detailed description is read with reference to the accompanying drawings in which like characters represent like parts throughout the drawings, wherein:

FIG. 1 is a block diagram of an instant messaging (IM) system configured for assisting user participants engaged in a communication session, using a bot engine integrated within at least one client application engine or on server or both according to an example embodiment of the present disclosure;

FIG. 2 illustrates an example instant messaging (IM) interface of a user device in an implementation of client application engine integrated with a bot engine and configured to facilitate automated messaging data, according to an example embodiment of the present disclosure;

FIG. 3 is a block diagram illustrating functional components of an example controller deployed in the bot engine integrated within the client application engine or the server or both, according to an example embodiment of the present disclosure;

FIG. 4 is a flow chart illustrating a method for generating and displaying automated messaging data to assist the user participants of the communication session according an example embodiment of the present disclosure;

FIG. 5 illustrates an example display screens of instant messaging (IM) user interface showing an exemplary chat session among the user participants and the bot participants according an example embodiment of the present disclosure; and

FIG. 6 is a block diagram of a computing device utilized for implementing instant messaging (IM) system, according to an embodiment of the present disclosure.

Further, skilled artisans will appreciate that elements in the figures are illustrated for simplicity and may not have necessarily been drawn to scale. Furthermore, in terms of the construction of a device, one or more components of the device may have been represented in the figures by conventional symbols, and the figures may show only those specific details that are pertinent to understanding the embodiments of the present disclosure so as not to obscure the figures with details that will be readily apparent to those of ordinary skill in the art having the benefit of the description herein.

### DETAILED DESCRIPTION

For the purpose of promoting an understanding of the principles of the disclosure, reference will be made to the embodiments illustrated in the figures and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. It will be understood by those skilled in the art that the foregoing general description and the following detailed description are exemplary and explanatory of the disclosure and are not intended to be restrictive thereof.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components. Appearances of the phrase “in an embodiment”, “in another embodiment”, “in one embodiment”, “in a further embodiment”, “in some embodiments”, “in certain embodiments” and similar language throughout this specification may, but do not necessarily, all refer to the same embodiment. Unless otherwise defined, all technical and scientific terms used herein have the same meaning as commonly understood by one of ordinary skill in the art to which this invention belongs. The system, methods, and examples provided herein are illustrative only and not intended to be limiting.

Some embodiments of the present disclosure may provide assistance to users/persons engaged in a communication chat or a group of users communicating with each other via an instant messaging service installed on a user device. In one embodiment, the assistance is provided through bot participants by displaying one or more automated messaging data on the display screen of the user device. In one embodiment, a system and method is disclosed configured for assisting users by providing automated messaging data, based on the communication initiated between two or more users, over a network.

Some example embodiments may provide an instant messaging (IM) system. The system includes a client application engine configured for operating on one or more devices. The client application engine is integrated with a bot engine configured for providing a plurality of automated instant messaging (IM) services to user participants of a communication session. In one embodiment, the bot engine may also be installed by the user in order to be integrated within the client application engine. The bot engine includes a controller. The controller is configured for monitoring messaging data being communicated across the user participants of the communication session. The controller is configured for analyzing the messaging data to filter one or more contextual keywords. The controller is further configured for generating automated messaging data based on the one or more contextual keywords. In addition, the controller is configured for displaying the automated messaging data to assist the user participants of the communication session.

Some embodiments may include a method for rendering automated messaging data to assist one or more user participants of the communication session. The method includes monitoring messaging data being communicated across the user participants of the communication session. The method also includes analysing the messaging data to filter one or more contextual keywords. In addition, the method includes generating automated messaging data based on the one or more contextual keywords. Moreover, the method includes displaying the automated messaging data to assist the user participants of the communication session.

In some embodiments, the word ‘bot’, ‘bot engine’, ‘automatons’ used in the description may reflect the same meaning and may be used interchangeably. The bot participants may also be referred to as BOTs or automatons.

In some embodiments, an instant messaging (IM) system disclosed herein may be explained by considering an example scenario. In an example embodiment, the instant messaging (IM) system may be configured for assisting user participants engaged in a communication session, using a bot engine integrated within at least one client application engine or on a server or both. In one example, the client application engine (also referred as client application or a messenger) may be an instant messaging service.

In one example, considering a scenario, where three different users are communicating with each other in a group through a messenger. For example, the ‘user participant 1’ messages ‘user participant 2’ asking for planning a dinner together with other users in the group. The ‘user participant 2’ replies texting “It's a nice idea” and ‘user participant 3’ comes up with a question, “where can we go?”!! The bot engine integrated within the client application engine installed on a user device (for example, mobile phone device) is configured to come up with a suggestion after monitoring and analysing the conversation. Further, the bot participants within the bot engine provides different options by displaying an automated messaging data —“You guys can go for restaurant DEF, GHI”. The bot engine is also configured to track the location (GPS location) of the user participants for generating the suggestion. In addition to the illustrative aspects, example embodiments, and features described above, further aspects, example embodiments of the present disclosure will become apparent by reference to the drawings and the following detailed description.

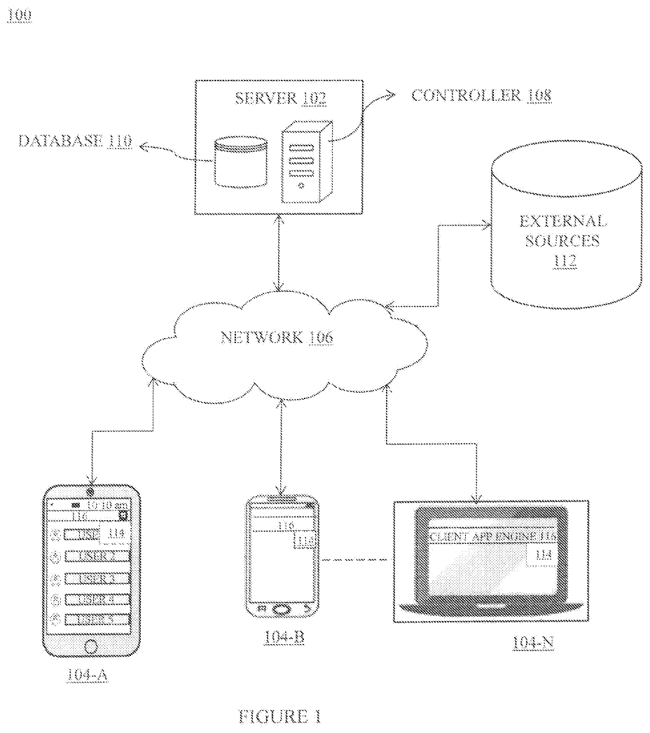

FIG. 1 is a block diagram of an instant messaging (IM) system 100 configured for assisting user participants engaged in a communication session, using a bot engine integrated with at least one client application engine or on server or both according to an example embodiment of the present disclosure. In particular, FIG. 1 comprises a server 102, and a plurality of devices 104-A through 104-N communicatively coupled via a network 106. The server 102 includes a controller 108 and a database 110. The server 102 is interconnected via network 106 to one or more external sources 112. A bot engine 114 may be integrated within client application engine 116. The client application engine 116 may be installed on plurality of devices 104-A through 104-N. Each component is described in further details below.

In one embodiment, the instant messaging (IM) system 100 may be configured for assisting user participants engaged in a communication session, using a bot engine 114 integrated with at least one client application engine 116. The bot engine 114 may also be situated on a server 102. In one embodiment, the system 100 is configured for enabling communication (instant messaging) between two or more user participants, over a network 106. In the illustrated embodiment, the system 100 may comprise the client application engine 116 configured to run on the plurality of user devices 104-A through 104-N.

In one example, the client application engine 116 may be an instant messaging client that may enable a user to communicate with friends or families over a network 106 or the internet. Examples of the instant messaging clients include but are not limited to Microsoft Messenger, Yahoo Messenger, Google Talk, Facebook Messenger, Whatsapp Messenger or combinations thereof.

As described above, the client application engine 116 may be configured to operate or may be installed on a plurality of devices 104-A through 104-N. In one embodiment, the devices 104-A through 104-N are associated with each of the two or more user devices. Examples of user devices 104-A through 104-N include, but are not limited to mobile phone device, a computer, a tablet, or any other user devices configured for instant messaging service. In one embodiment, a bot engine 114 may be integrated within the client application engine 116 installed on the user device (104). In another embodiment, the bot engine 114 may be located on a server 102. In the same embodiment, the entire messaging data is transmitted to the server 102 for processing and generating automated messaging data.

In one embodiment, the bot engine 114 is configured to monitor the messages being communicated through the client application engine 116 between two or more user participants. In the illustrated embodiment, the bot engine 114 is configured to monitor one or more data inputs received from external applications and hardware components of the user device (104).

In one embodiment, the bot engine 114 is configured for providing a plurality of automated instant messaging (IM) services to user participants of a communication session. In one example, the bot engine 114 may be an Internet bot, also known as web robot, WWW robot or simply bot. In one embodiment, the bot engine 114 may be a software application that runs or executes automated tasks (scripts) over the Internet. In one embodiment, the bot engine 114 is configured to perform tasks that are both simple and structurally repetitive, at a much higher rate than would be possible for a human alone. For conciseness, the bot engine 114 is a Robot or an automaton configured for executing a program that operates as a robot for a user or another program or simulates a human activity.

In one embodiment, the messaging data is the data, information, instant messages or the communication data exchanged between the user participants chatting or communicating over a chat messenger (referred to as client application engine 116). In another embodiment, the automated messaging data is the suggestion, command which is generated after monitoring and analyzing the messaging data (conversation).

In the illustrated embodiment, the bot engine 114 comprises a controller 108 configured for monitoring messaging data being communicated across the user participants of the communication session. The messaging data being communicated across the participants of the communication session is monitored each time the communication is initiated between the user participants. Further, the controller 108 is configured for analysing the messaging data to filter one or more contextual keywords. In one example embodiment, a filter engine (not shown) is configured to receive the messaging data being monitored and further configured to filter the relevant contextual data. In addition, the controller 108 is configured for generating automated messaging data based on the one or more contextual keywords. The automated messaging data is generated either from a plurality of stored responses in one or more databases 110 or fetched from external sources 112 or both. The automated messaging data is generated based on the fetched data which is fetched in real-time from the external sources 112.

In one embodiment, the automated messaging data is generated automatically or based on request received from at least one user participants. The controller 108 is configured for generating the automated messaging data on execution of said steps. In one example, the first step includes storing the contextual keywords in a repository (not shown). In one embodiment, the repository is present in the controller 108. Secondly, the controller 108 is then configured for accessing data stored in one or more databases (110). Lastly, the controller 108 is configured for comparing the stored contextual keywords in repository against the data accessed in several databases (110) to generate automated messaging data. In one example embodiment, the automated messaging data are the responses displayed by the bots participants. In one embodiment, the bot participants are configured to include text messages that are entered into the instant messaging session from which the runtime input had been received. The runtime input received is the messaging data being communicated across the user participants of the communication session.

In one embodiment, the automated messaging data is associated to at least one of the IM services. Examples of IM services include services, but not limited to education services, translation services, payment services, geographic locations services, weather services, recommendation services, gaming services or combinations thereof. In one embodiment, the IM services are communication services.

In one embodiment, the database 110 is configured to store information that is used by the controller 108 to generate automated messing data. The controller 108 is configured to interpret the messaging data (conversation between users) and access the information present in the databases 110 to generate the automated messaging data. In one embodiment, the controller 108 is also configured to fetch data from external sources 112 in real-time. The database 110 may also store various sentence structure rules associated with the respective language so that the bot participants can respond based on the messaging data monitored and analyzed by the bot engine 114 in the communication session. In another example embodiment, the database 110 is also configured to store a link to a plurality of questions. The questions are generated based on filtered data and contextual keywords. The question list may include a link to an answer list. The answer list may include a list of at least one search result from each one of the plurality of search databases. In one embodiment, the database 110 is configured to store one or more actions or tasks to be executed by the bot engine 114 through a trigger module (not shown). The trigger module 114 is configured to schedule the display of automated messaging data by the bot participants.

In one embodiment, the controller 108 is configured for displaying the automated messaging data to assist the user participants of the communication session. In one example, the bot engine 114 comprises one or more bot participants configured for displaying the automated messaging data. For example, an instant messaging session display is a user display that is presented at a workstation, such as a screen on a personal computer, a personal digital device or a cellular phone, to allow a user to participate in an instant messaging session or a communication session.

The network 106 may be the Internet or Wide Area Network (WAN) or other like network that covers a broad area, such as a personal area network (PAN), local area network (LAN), campus area network (CAN), metropolitan area network (MAN), a virtual local area network, or other like network capable of physically connecting computers and other devices.

In some embodiments, a manner in which system 100 of FIG. 1 operates for assisting user participants engaged in a communication session, using a bot engine 114 integrated with at least one client application 116 is described in detail further below.

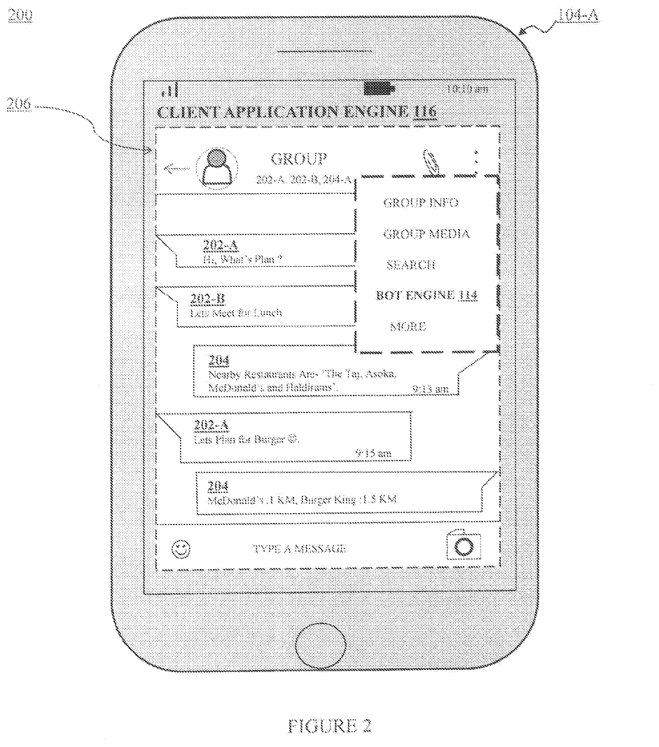

FIG. 2 illustrates an example instant messaging (IM) interface 200 of a user device in an implementation of client application engine integrated with a bot engine and configured to facilitate automated messaging data, according to an example embodiment of the present disclosure. In particular, FIG. 2 illustrates a bot engine 114 integrated within a client application 116. The client application 116 is installed on the user device 104-A. Moreover, the interface 200 illustrates the user participants (user 202-A and user 202-B) engaged in a communication session, using the bot engine 114 integrated within the client application engine 116. The user participants 202-B may be a user who is using the client application engine 116 which is installed on the user device 104-B.

In one example embodiment, the client application engine 116 may be an instant messaging client (also referred as a chat messenger) that may enable the user participants (user 202-A and user 202-B) to communicate with each other over a network 106 or the internet. Examples of the instant messaging clients include but are not limited to Microsoft Messenger, Yahoo Messenger, Google Talk, Facebook Messenger, Whatsapp Messenger or combinations thereof.

In one embodiment, the user participants (202-A and 202-B) are exemplary human users that are communicating with each other in an instant messaging system configuration. In addition to these human users, the exemplary embodiment of the present invention includes exemplary instant messaging Bots also referred as bot participants. The bot participant is indicated by reference numeral 204. For example, the bot participants are commonly referred to as RoBots or just “Bots.” The exemplary instant messaging Bots of the exemplary embodiment become participating members of instant messaging sessions just like any other client or user, including human clients such as user participants (202-A and 202-B).

Referring to FIG. 2, an instant messaging (IM) interface 200 of a user device, the IM interface 200 depicts the text message (Hi, What's Plan?) by the user participants 202-A to the user participants 202-B. In response to the text message by the user participants 202-A, the user participants 202-B replies with a text message “Lets Meet for Lunch”. In one embodiment, based on the communication and exchange of messaging data between the user participants (202-A and 202-B), the bot participant 204 comes up with a suggestion by displaying automated message on the display screen 206 of the IM interface 200. The automated messages (automated messaging data) are “Nearby Restaurants Are—‘The Taj, Asoka, McDonald's and Haldirams.” Subsequently, the user participants 202-A responds with the messaging data as “Lets Plan For Burger [symbol] ”. In one embodiment, based on the further communication and exchange of messaging data between the user participants (202-A and 202-B), the bot participant 204 comes up with a suggestion by displaying automated message on the display screen 206 of the IM interface 200. The automated messages are:—“McDonald's: 1KM, “Burger King”: 1.5 KM”.

In one embodiment, the bot engine 114 is configured to monitor the messaging data being communicated through the client application engine 116 between two or more user participants (202-A and 202-B). In the illustrated embodiment, the bot engine 114 is configured to monitor one or more data inputs received from external applications and hardware components of the user device (104). In one embodiment, the bot engine 114 is configured for providing a plurality of automated instant messaging (IM) services to user participants of a communication session.

In the illustrated embodiment, the bot engine 114 comprises a controller 108 configured for monitoring messaging data being communicated across the user participants (202-A and 202-B) of the communication session. In this example, the messaging data: “Hi, What's Plan? And “Lets Meet for Lunch” is monitored by the controller 108 embedded in the bot engine 114. Further, the controller 108 is configured for analysing the messaging data to filter one or more contextual keywords. The contextual data filtered by the bot engine 114 is “lunch” based on the messaging data exchanged between the user participants (202-A and 202-B). The bot engine 114 filters the contextual keywords which are smartly analyzed to generate the automated messaging data. The controller 108 is configured for generating automated messaging data based on the one or more contextual keywords. In this example, ‘lunch’ is the contextual keyword. The automated messaging data is generated either from a plurality of stored responses in one or more databases 110 or fetched from external sources 112. In one embodiment, the automated messaging data is generated automatically or based on request received from at least one user participants. The controller 108 is configured for generating the automated messaging data on execution of said steps. In one example, the first step includes storing the contextual keywords in a repository. In one embodiment, the repository is present in the controller 108. Secondly, the controller 108 is then configured for accessing data stored in one or more databases (110).

In one example embodiment, the automated messaging data are the responses displayed by the bots participants. In the illustrated example scenario, as shown on IM interface 200, the automated messages are “Nearby Restaurants Are —‘The Taj, Asoka, McDonald's and Haldirams.” In one embodiment, based on the contextual keyword “lunch”, the bot engine 114 has generated the automated messaging data to display the nearby restaurants to assists the user participants (202-A and 202-B).

In one example embodiment, based on the subsequent communication between the user participants (202-A and 202-B), the contextual keyword filtered by the bot engine 114 is “burger”. In one embodiment, based on the contextual keyword “burger”, the bot engine 114 has generated the automated messaging data to display the nearby burger restaurants to assists the user participants (202-A and 202-B). The bot engine 114 is also configured to detect the location of the user device 104 and suggest the nearby restaurants along with the distance from the user device 104. In this example, the bot participants displays the automated messaging data “McDonald's: 1KM, “Burger King”: 1.5 KM”.

In some embodiments, the controller 108 embedded in the bot engine 114 is configured to store the messaging data in the repository (not shown). The controller 108 is further configured to constantly update the repository with latest information such as the current location of the users to map against the data available on external sources 112. The generator engine 306 is then configured to generate the automated messaging data based on the updated information present in the repository and data available on the external sources 112. The automated messaging data is generated based on the data fetched in real-time from the external sources 112. The paragraph described herein illustrates an example scenario with respect to the illustrated embodiment.

For example, the users using the user devices (104) are in Mumbai. As mentioned earlier, the bot engine 114 may be integrated within client application engine 116 which is installed on plurality of devices 104-A through 104-N. In the illustrated exemplary embodiment, the controller 108 is configured for generating automated messaging data based on contextual keywords and the location of the users communicating with each other. For example, the contextual keywords may be ‘lunch’ or ‘food’ or ‘hungry’. In the illustrated embodiment, the controller 108 is configured to provide an automated messaging data suggesting restaurants, which may be at an equidistant location to the user participants. In the same embodiment, the automated messaging data (which are suggested restaurants) is generated based on the one or more factors. For example, one of the factor may be the best restaurants with good quality food and is rated as ‘good’ by a rating website. For example, ‘Zomato’ website provides information with respect to the nearby restaurants, restaurants rated with best food etc. In one embodiment, the external source 112 with respect to this example is the ‘Zomato’ website. The automated messaging data is generated in real time based on the fetched data from the ‘Zomato’ website.

In one embodiment, the controller 108 is configured to generate the automated messaging data, based on the GPS locations of the users and an external source 112 like ‘Zomato’ API in real-time. In yet another embodiment, the controller 108 is also configured to generate messaging data based on the location of plurality of user participants communicating in a group. For example, a plurality of users are communicating with each other in a group using the client application engine 116. For example more than five users are communicating with each other in a group using the client application engine 116. The controller 108 embedded in the bot engine 114 is configured to pre-compute the automated messaging data in real time based on the GPS locations of all the five users. In one embodiment, the computation and generation of the automated messaging data is not limited to five users and includes more than five users or more users too.

In one embodiment, a manner in which the controller 108 of system 100 of FIG. 1 operates for generating and displaying automated messaging data to assist the user participants of the communication session is described in detail further below.

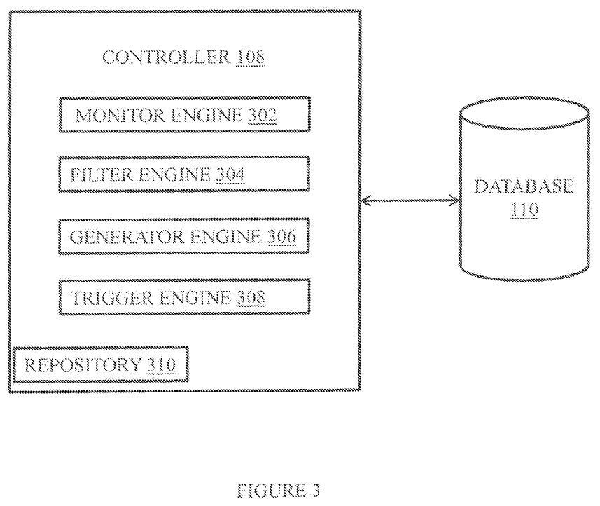

FIG. 3 is a block diagram 300 illustrating functional components of an example controller 108 deployed in the bot engine 114 integrated within the client application engine 116 or the server 102 or both, according to an example embodiment of the present disclosure. In particular, FIG. 3 illustrates the controller 108 and the database 110. The controller 108 includes a monitor engine 302, a filter engine 304, a generator engine 306, a trigger engine 308 and a repository 310. Each component is described in further details below.

In one embodiment, the client application engine 116 is configured for operating on one or more devices. For example, the devices may be user devices (104). In one embodiment, the bot engine 114 is configured for providing a plurality of automated instant messaging (IM) services to user participants of a communication session. In one embodiment, a bot engine 114 may be integrated within the client application engine 116 installed on the user device (104). In another embodiment, the bot engine 114 may be located on a server 102. In the same embodiment, the entire messaging data is transmitted to the server 102 for processing and generating automated messaging data. In another embodiment, the bot engine 114 comprises a controller 108.

Referring to FIG. 3, the controller 108 includes a monitor engine 302 configured for monitoring messaging data being communicated across the user participants of the communication session. For example, the monitor engine 302 is configured to monitor the messages being communicated through the client application engine 116 between two or more user participants. In the illustrated embodiment, the monitor engine 302 is configured to monitor one or more data inputs received from external applications and hardware components of the user device (104). Furthermore, the controller 108 includes the filter engine 304 configured for filtering the contextual keywords from the messaging data being communicated across the user participants of the communication session. In one example, the filter engine 304 automatically fetches the script data present in the messaging data and analyses the messaging data through the use of servers (102). In one embodiment, the controller 108 includes the generator engine 306 configured for generating the automated messaging data. The generator engine 306 is configured for generating the automated messaging data on execution of said steps. In one example, the first step includes storing the contextual keywords in a repository 310. In one embodiment, the repository 310 is present in the controller 108. Secondly, the generator engine 306 is then configured for accessing data stored in one or more databases (110). Lastly, the generator engine 306 is configured for comparing the stored contextual keywords in repository 310 against the data accessed in several databases (110) to generate automated messaging data.

In one embodiment, the controller 108 includes the trigger engine 308 configured for scheduling the display of automated messaging data through the bot participants either at an instant during the communication session or at an another instant as scheduled by at least one user participants. For example, the trigger engine 308 is configured to schedule and trigger the display of command or suggestions based on the fetched data through repository 310 or any other databases (110) on the server 102. According to various embodiments, the database 110 may include one or more databases, but not limited to databases such as educational information database, movie database, travel database, restaurant database, telephone number database, weather database, user device database or combinations thereof.

In one example embodiment, the automated messaging data are the responses displayed by the bots participants. In one embodiment, the bot participants are configured to include text messages that are entered into the instant messaging session from which the runtime input has been received. In some embodiments, the above described system 100 may be implemented for generating and displaying automated messaging data to assist the user participants of the communication session. In some other embodiments, a manner in which the automated messaging data is generated and displayed is described in further detail below.

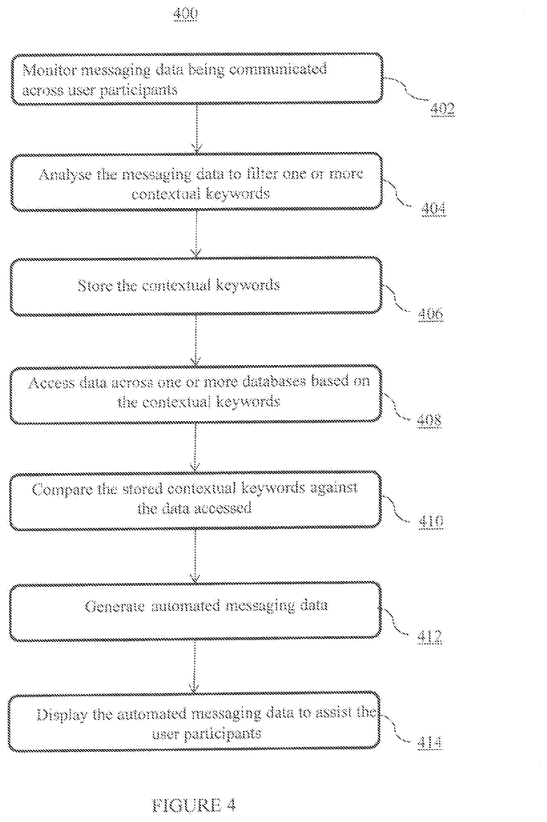

FIG. 4 is a flow chart illustrating a method 400 for generating and displaying automated messaging data to assist the user participants of the communication session according an example embodiment of the present disclosure. FIG. 4 may be described from the perspective of a controller 108 that is configured to execute computer-readable instructions to carry out the functionalities of the above described modules and/or engines of the system 300 shown in FIG. 3.

In particular, the steps as described in FIG. 4 may be executed for providing a plurality of automated instant messaging (IM) services to user participants of a communication session. In one embodiment, the messaging data is the data, information, instant messages or the communication data exchanged between the user participants chatting or communicating over a chat messenger (referred to as client application engine 116). In another embodiment, the automated messaging data is the suggestion, command which is generated after monitoring and analyzing the messaging data (conversation).

In one embodiment, a bot engine 114 may be integrated within the client application engine 116 installed on the user device (104). In another embodiment, the bot engine 114 may be located on a server 102. In the same embodiment, the entire messaging data is transmitted to the server 102 for processing and generating automated messaging data. In another embodiment, the bot engine 114 comprises a controller 108.

At step 402, messaging data being communicated across two or more user participants is monitored. At step 404, the messaging data is analyzed to filter one or more contextual keywords. At step 406, the contextual keywords are stored. At step 408, data across one or more databases is accessed based on the contextual keywords. At step 410, the stored contextual keywords are compared against the data accessed. At step 412, the automated messaging data is generated. At step 414, the automated messaging data is displayed to assist the user participants.

In an example embodiments, with reference to step 402, the monitor engine 302 existent in the controller 108 is configured for monitoring messaging data being communicated across the user participants of the communication session. For example, the monitor engine 302 is configured to monitor the messages being communicated through the client application engine 116 between two or more user participants. In the illustrated embodiment, the monitor engine 302 is configured to monitor one or more data inputs received from external applications and hardware components of the user device (104).

In some embodiments, with reference to step 404, the filter engine 304 is configured for filtering the contextual keywords from the messaging data being communicated across the user participants of the communication session. In one example, the contextual keywords are relevant keywords present in the messaging data. In one example embodiment, when the relevant keyword is lunch, the contextual keyword is ‘Munch’. In one embodiment, the bot engine 114 is configured to scan the contextual keywords as the conversation occurs between the user participants. The bot engine 114 is invoked by either using the keywords or invoking through a specific symbol say (#)—say # lunch options.

In one example, the filter engine 304 automatically fetches the script data present in the messaging data and analyses the messaging data through the use of servers (102). In some embodiments, with reference to step 406, the contextual keywords are stored in a repository 310. In one embodiment, the repository 310 is present in the controller 108. In some embodiments, with reference to step 408, data is accessed in one or more databases (110). According to various embodiments, the database 110 may include one or more databases, but not limited to databases such as educational information database, movie database, travel database, restaurant database, telephone number database, weather database, user device database or combinations thereof. In one embodiment, the database 110 is configured to store information that is used by the controller 108 to generate automated messaging data (step 412). The controller 108 is configured to interpret the messaging data (conversation between users) and access the information present in the databases 110 to generate the automated messaging data (step 412). In one embodiment, the controller 108 is also configured to fetch data from external sources 112 in real-time.

In some embodiments, with reference to step 410, the generator engine 306 is configured for comparing the stored contextual keywords in repository 310 against the data accessed in several databases (110) to generate the automated messaging data (step 412). In one embodiment, the automated messaging data is generated in real-time from a plurality of stored responses in one or more databases or fetched from external sources. In another embodiment, the automated messaging data is generated in real-time from a plurality of stored responses in one or more databases and fetched from external sources.

In some embodiments, with reference to step 414, the trigger engine 308 is configured to schedule and trigger the display of automated messaging data based on the fetched data through repository 310 or any other databases (110) on the server 102. In one example embodiment, the automated messaging data are the responses displayed by the bots participants. In one embodiment, the bot participants are configured to include text messages that are entered into the instant messaging session from which the runtime input had been received. The above described system and method for displaying automated messaging data to assist the user participants of the communication session may employ several instant messaging (IM) interfaces. Some example interfaces are described in further detail below with regard to an example chat or communication session between two or three users. It is noted that the present technique is by no means intended to be limited to these example embodiments.

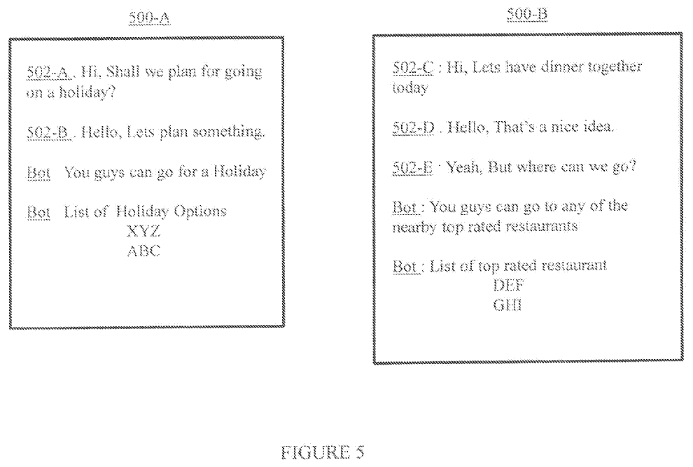

FIG. 5 illustrates an example display screen 500-A and 500-B of instant messaging IM user interface showing an exemplary chat session among the user participants and the bot participants according an example embodiment of the present disclosure. Referring to screen 500-A, two user participants are communicating with each other. In one embodiment, the user participants are communicating using a client application engine 116. For example, the client application engine 116 may be a ‘what's app messenger’. As an illustrative example, as shown by reference numeral 500-A in FIG. 5, user participant (user 502-A) initiates a communication with user participant (user 502-B). In this example, while user 502-A has plans of travelling on a holiday and sends a message to user 502-B by texting, “Hi, Shall we plan for going on a holiday? In response to the message of user 502-A, the user 502-B replies:—Hello, Lets plan something.

In one embodiment, the bot engine 114 integrated with the client application engine installed 116 on a user device (for example, mobile phone device) is configured to come up with a suggestion (by bot participants) after monitoring and analysing the conversation. In this example, the bot participants become a part of a conversation and suddenly the bot participants comes up with suggestions during the communication. For example, the bot participants displays the messages:—You guys can go for a Holiday. In another example, the bot participants also displays the ‘List of Holiday Options as ‘XYZ’ and ‘ABC’.

Referring to screen 500-B, three different user participants are communicating among each other in a group through client application device 116 (a Facebook chat messenger). The user participant 502-C messages user participant 502-D asking for planning a dinner together with other users in the group. In one example, the user participant 502-D replies texting “Hello, That's a nice idea” and user participant 502-E comes up with a question, “where can we go?” In one embodiment, the bot engine 114 integrated within the client application engine 116 on a user device (for example, mobile phone device 104-A) is configured to come up with a suggestion (by bot participants) after monitoring and analysing the conversation. In this example, the bot participants become a part of a conversation and the bot participants comes up with suggestions during the communication. For example, the bot participants displays the messages:—“You guys can go for restaurant DEF, GHI” . . . based on the one or more user(s) location”.

Moreover, the embodiments described above may be utilized by a user or a plurality of users communicating with each other using one or more data processing devices. In one embodiment, the integration of the bot engine 114 into the client application engine 116 (for example, a chat messenger) may also implement an internet of things (IoT) for monitoring and operating purposes. The Internet of Things (IoT), also referred as Internet of Everything is the network of physical objects or “things” embedded with electronics, software, sensors, and connectivity to enable objects to exchange data with the manufacturer, operator and/or other connected devices based on the infrastructure of International Telecommunication Union's Global Standards Initiative. The implementation of above described system 100 may also be understood by an example scenario as described in detail below. The implementation of above described system 100 is not limited to example embodiments described herein and these techniques find applications in a wide variety of businesses.

In one exemplary embodiment, let us consider a bot engine 114 called as “Running with Friends” automaton. The purpose of the automaton “Running with Friends” is to assist people who are a part of a group formed on a chat messenger (client application engine 116). In the below paragraphs, the automaton “Running with Friends” is referred by the word automaton. The automaton “Running with Friends” which is integrated within the (client application engine 116) assists the users of the client application engine 116 to wake up in the morning, informs users the place to run along with other members of the group, receive navigational support from the phone, ensure the weather (using weather services) is safe and also to celebrate the runners who have completed the run. Further, in another exemplary embodiment, the operational method of the “automaton “Running with Friends” may be as follows.

In one example embodiment, a scheduler may trigger the automaton at a specified time of a day and start executing a program. The automaton after the trigger, may check for GPS locations (by using geographic locations services) of all the members who are a part of a group using the GPS or other sensors on the mobile phone or any user device. The automaton, however, also checks for the last time a member was active in the group to decide if an inactive member should be contacted or not. The group also contains other discussions amongst the group members. The entire information with respect to discussion among the members of the group is sent to the filter engine (304 of FIG. 3). The job of the filter engine (304) is to filter the information that is relevant to the automaton operation and ignore the other pieces of information. For example in this case, all the group chat information that is not relevant to the meeting is ignored and the rest of the information is sent to the controller 108 for processing. The automaton first sends a group message asking the group members if they would like to run the next morning at a specified time. This input is filtered through the filter engine (304) to generate subsequent automated messaging data.

The controller 108 processes the instructions and creates notification messages for all members who elected to run and stores them in the repository 310. Then a trigger is created and the automaton is scheduled to send messages to everyone the next morning. In one embodiment, the controller 108 also checks for programmed used cases. In this case, it may check the number of group members who are located nearby and suggest meeting at a particular location which is accessible to all the runners. Once the people show up at the location, the automaton uses the barometer, light sensor or any other sensor to detect running conditions and relays it to the runners so that they can tune their running style or pace accordingly. Once the run starts, the controller 108 continuously uses data from the accelerometer, the gyroscope, the pedometer, the GPS or others to track how much each runner is running and the distance they have covered. The controller 108 also uses the functionality of automatons, the GPS and the magnetometer and others to track the direction of the run. The controller 108 also configure to monitor the health of each runner, using the heart rate monitor, and makes suggestions on speeding up or slowing down. Once the run is complete, the controller 108 can use the finger print sensor or other sensor to authenticate that it was the owner of the phone who completed the run. In one embodiment, after the run, the users can record a victory message and also take a group picture using the camera, which can be posted into the group. The controller 108 then again checks for a list of restaurants that fit the criteria of being near the members, open and also accepting reservations through the restaurant database or a similar service's API. This data is processed and then stored in the repository 310.

In one embodiment, the trigger engine (308) checks if all the criterion of the program have been fulfilled (i.e. checking if a minimum of members have been processed or not) and based on the rules would take the information from the repository 310 and pass it onto the scheduler. The job of the scheduler is to then schedule when the messages to the group members need to be sent. For example, a breakfast meeting can be computed a day before, but the alerts can be sent just before the breakfast. The information of the run along with the data like the distance, time taken and group photographs are share worthy, so the controller 108 is programmed to hand over the data to the repository 310 which then waits for a trigger of the group run completion. After the trigger is received, it shares the messages, run details and group photographs to everyone in the group.

Further, in another embodiment, the automaton may also be used for payments and transactions within the group or individual users. For example, the automaton may be called as Deal of the day′. This automaton may help complete the transaction processing within the chat/group interface itself. One of the examples is provided below in detail to explain the embodiment.

The example with respect to above embodiment is as follows, considering the group of people i.e. one or more users are having a conversation and they start discussing about new product in the market. The automatons may come up with a suggestion offering complete specification of product and its cheapest price. If the users would like to buy that product then automatons will provide the option for payment and transaction in the messenger itself, so the user(s) don't need to go to other websites for transactions. In another embodiment the automatons may also be used for natural language processing (NLP) and voice data processing, wherein NLP is a field of computer science, artificial intelligence, and computational linguistics concerned with the interactions between computers and human natural languages.

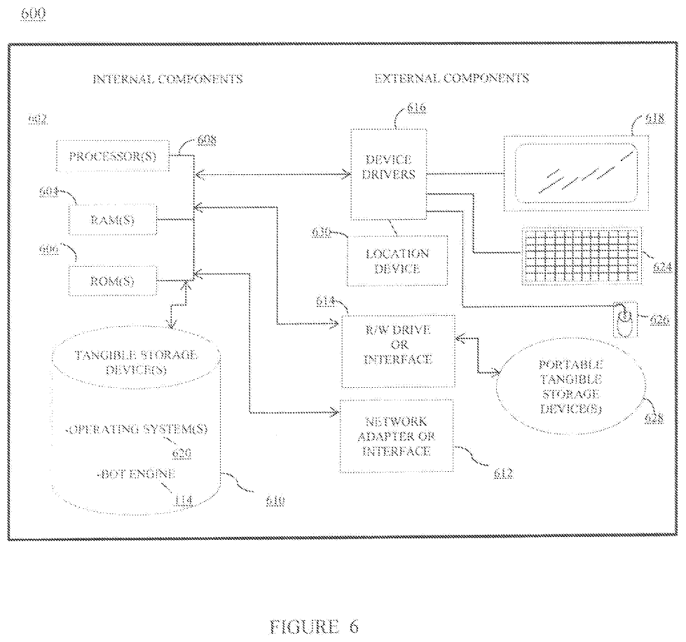

FIG. 6 is a block diagram of a computing device 600 utilized for implementing instant messaging (IM) system 100, according to an embodiment of the present disclosure. The modules of the instant messaging (IM) system 100 described herein are implemented in computing devices. One example of a computing device 600 is described below in FIG. 6. The computing device comprises one or more processor 602, one or more computer-readable RAMs 604 and one or more computer-readable ROMs 606 on one or more buses 608. Further, computing device 600 includes a tangible storage device 610 that may be used to execute operating systems 620 and modules existing in controller 108 of instant messaging (IM) system 100. The various modules of the controller 108 including a monitor engine 302, a filter engine 304, a generator engine 306, a trigger engine 308 can be stored in tangible storage device 610. Both, the operating system and the modules existing in controller 108 of system 100 are executed by processor 602 via one or more respective RAMs 604 (which typically include cache memory).

Examples of storage devices 610 include semiconductor storage devices such as ROM 606, EPROM, flash memory or any other computer-readable tangible storage device 610 that can store a computer program and digital information. Computing device also includes R/W drive or interface 614 to read from and write to one or more portable computer-readable tangible storage devices 628 such as a CD-ROM, DVD, memory stick or semiconductor storage device. Further, network adapters or interfaces 612 such as a TCP/IP adapter cards, wireless wi-fi interface cards, or 3G or 4G wireless interface cards or other wired or wireless communication links are also included in computing device 600. In one embodiment, the modules existing in controller 102 can be downloaded from an external computer via a network (for example, the Internet, a local area network or other, wide area network) and network adapter or interface 612. Computing device 600 further includes device drivers 616 to interface with input and output devices. The input and output devices can include a computer display monitor 618, a keyboard 624, a keypad, a touch screen, a computer mouse 626, and/or some other suitable input device.

While specific language has been used to describe the disclosure, any limitations arising on account of the same are not intended. As would be apparent to a person skilled in the art, various working modifications may be made to the method in order to implement the inventive concept as taught herein. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1. An instant messaging (IM) system comprising:
a client application engine configured for operating on one or more devices; and
a bot engine configured for rendering a plurality of instant automated messaging data to user participants of a communication session; wherein the bot engine comprises a controller configured for:
monitoring a messaging data being communicated across the user participants of the communication session;
analysing the messaging data to filter one or more contextual keywords;
generating the automated messaging data based on the one or more contextual keywords; and
displaying the automated messaging data to assist the user participants of the communication session.

2. The instant messaging (IM) system as claimed in claim 1, wherein the bot engine is integrated within the client application engine or a server or both.

3. The instant messaging (IM) system as claimed in claim 1, further comprising one or more bot participants configured for displaying the automated messaging data.

4. The instant messaging (IM) system as claimed in claim 1, wherein the automated messaging data is generated automatically or based on request received from at least one user participants.

5. The instant messaging (IM) system as claimed in claim 1, wherein the controller is configured for generating the automated messaging data on execution of said steps; wherein the said steps comprises:
storing the contextual keywords in a repository;
accessing data stored in one or more databases; and
comparing the stored contextual keywords against the data accessed to generate automated messaging data.

6. The instant messaging (IM) system as claimed in claim 5, wherein the automated messaging data is generated in real-time from:
plurality of stored responses in one or more databases or fetched from external sources; and
plurality of stored responses in one or more databases and fetched from external sources.

7. The instant messaging (IM) system as claimed in claim 1, wherein the controller comprises a filter engine configured for filtering the contextual keywords from the messaging data being communicated across the user participants of the communication session.

8. The instant messaging (IM) system as claimed in claim 1, wherein the controller comprises a triggering engine configured for scheduling the display of automated messaging data through the bot participants either at an instant during the communication session or at an another instant as scheduled by at least one user participants.

9. The instant messaging (IM) system as claimed in claim 1, wherein the communication session is established between two users participants, or a group of user participants.

10. The instant messaging (IM) system as claimed in claim 1, wherein the messaging data being communicated across the participants of the communication session is monitored each time the communication is initiated between the user participants.

11. A method for rendering automated messaging data to assist one or more user participants of a communication session, the method comprising:
monitoring a messaging data being communicated across the user participants of the communication session;
analysing the messaging data to filter one or more contextual keywords;
generating the automated messaging data based on the one or more contextual keywords; and
displaying the automated messaging data to assist the user participants of the communication session.

12. The method as claimed in claim 11, wherein generating the automated messaging data on execution of said steps; wherein the said steps comprises:
storing the contextual keywords in a repository;
accessing data stored in one or more databases; and
comparing the stored contextual keywords against the data accessed to generate the automated messaging data.

13. The method as claimed in claim 11, further comprising scheduling the display of the automated messaging data through one or more bot participants either at an instant during the communication session or at an another instant as scheduled by at least one user participants.

14. The method as claimed in claim 11, wherein generating the automated messaging data either from a plurality of stored responses in one or more databases or fetched from external sources.
